(19) United States
(12) Patent Application Publication
(10) Pub. No.: US 2007/0028191 A1
(43) Pub. Date: Feb. 1, 2007

(54) Electronic device and storage medium for control program thereof

(75) Inventor: Hiroyuki Tsuji, Osaka (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 11/161,364

(22) Filed: Aug. 1, 2005

(51) Int. Cl. G06F 3/00

(52) U.S. Cl. 715/856

(57) ABSTRACT

An electronic device is disclosed that can scroll a display screen displayed by means a display apparatus thereon in line units as well as in page units by means of operating only the up and down cursor keys. With this electronic device, a mode setting means sets a page scroll mode in order to scroll the display screen by page units if a predetermined operation is performed with at least one of either the up cursor key or the down cursor key. A determination means determines whether or not the page scroll mode has been set when only one of either the up cursor key or the down cursor key has been operated. A scrolling means both scrolls the display screen in page units in the direction of the up cursor key or down cursor key that was operated if the determination means determines that the page scroll mode has been set, and resets the page scroll mode.

### BACKGROUND OF THE INVENTION

1. Field of the Invention

The present invention relates to an electronic device which has a display apparatus and an up cursor key and a down cursor key for scrolling the display screen displayed in the display apparatus in line units, and to a storage medium for a control program thereof.

2. Background Information

A control panel for an electronic device such as a copy machine has various operating keys in addition to a display apparatus. The display screen displayed on the display apparatus can be scrolled by operating either an up cursor key or a down cursor key (hereinafter also referred to as up and down cursor keys). In this case, when the up or down cursor key is pressed once, the screen will scroll by one line. Furthermore, when the up or down cursor key is held down, the screen will scroll continuously.

In addition, there are also devices which scroll the display screen by page units (units equivalent to a plurality of lines corresponding to the height of the display screen region), but in this case, a key other than the up or down scrolling key must be operated. See, for example, Japanese Patent Application Publication No. 2002-62764 and Japanese Patent Application Publication No. 2001-245351.

An object of the present invention is to provide an electronic device which can scroll the display screen displayed by the display apparatus in line units as well as in page units by operating only the up and down cursor keys. This invention addresses this object as well as other objects, which will become apparent to those skilled in the art from this disclosure.

### SUMMARY OF THE INVENTION

The electronic device according to a first aspect of the present invention includes an display apparatus, and an up cursor key and a down cursor key for moving a cursor displayed on the display apparatus and for scrolling the display screen displayed on the display apparatus in line units. The electronic device includes mode setting means, determination means, and scrolling means. The mode setting means sets a page scroll mode in order to scroll the display screen by page units if a predetermined operation is performed with at least one of either the up cursor key or the down cursor key. The determination means determines whether or not the page scroll mode has been set when only one of either the up cursor key or the down cursor key has been operated. The scrolling means both scrolls the display screen in page units in the direction of the up cursor key or down cursor key that was operated if the determination means determines that the page scroll mode has been set, and also resets the page scroll mode.

The electronic device according to a second aspect of the present invention is the electronic device of the first aspect, wherein the setting means sets the page scroll mode if the up cursor key and the down cursor key are simultaneously operated.

The electronic device according to the third aspect of the present invention is the electronic device of the first aspect, wherein the setting means sets the page scroll mode if at least one of the up cursor key or the down cursor key has been operated for more than a predetermined period of time.

The electronic device according to a fourth aspect of the present invention is the electronic device of the first aspect, wherein the setting means sets the page scroll mode if at least one of the up cursor key or the down cursor key has been operated a predetermined number of times.

The electronic device according to a fifth aspect of the present invention is the electronic device of the first aspect, wherein the up cursor key and the down cursor key are located apart from each other, and the setting means sets the page scroll mode if a region between the up cursor key and the down cursor key is operated.

The electronic device according to a sixth aspect of the present invention is the electronic device of the first aspect, further comprising an image forming unit for forming an image on a transfer material.

The storage medium according to a seventh aspect of the present invention is a storage medium which stores a control program executed by an electronic device which has a display apparatus, and an up cursor key and a down cursor key for moving a cursor displayed in the display apparatus and for scrolling the display screen displayed in the display apparatus in line units. The control program causes the electronic device to execute mode setting means, determination means, and scrolling means. The mode setting means sets a page scroll mode in order to scroll the display screen by page units if a predetermined operation is performed with at least one of either the up cursor key or the down cursor key. The determination means determines whether or not the page scroll mode has been set when only one of either the up cursor key or the down cursor key has been operated. The scrolling means both scrolls the display screen in page units in the direction of the up cursor key or down cursor key that was operated if the determination means determines that the page scroll mode has been set, and also resets the page scroll mode.

The present invention is able to scroll the display screen displayed by the display apparatus in line units as well as in page units by operating only the up and down cursor keys.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a block diagram showing the structure of a copy machine according to an embodiment of the present invention;

FIG. 2 is a schematic diagram showing a portion of a list screen displayed on a liquid crystal display unit of a copy machine;

FIG. 3 is a schematic diagram which describes the vertical scrolling in line units and vertical scrolling in page units of a liquid crystal display unit;

FIG. 4 is a flowchart showing the procedure for controlling the scrolling by means of the control unit of a copy machine;

FIG. 5 is a plan view showing a display screen which includes up and down cursor keys displayed on a liquid crystal display unit of an image forming device according to another embodiment of the present invention;

FIG. 6 is a plan view showing a key entry unit of an image forming device according to another embodiment of the present invention; and

FIG. 7 is a plan view showing a portable phone according to another embodiment of the present invention.

### DETAILED DESCRIPTION OF THE PREFERRED EMBODIMENTS

A preferred embodiment of the present invention in which the present invention is applied to a copy machine will be described below with reference to the drawings.

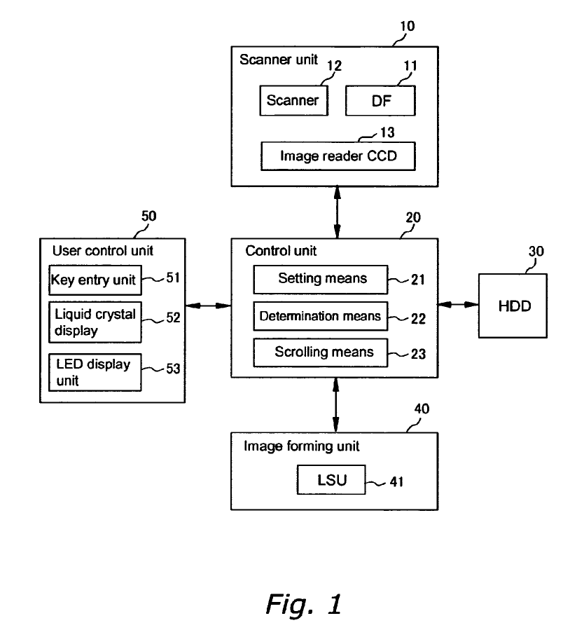

FIG. 1 shows a schematic structure of a digital copy machine. A digital copy machine comprises a scanner unit 10, a control unit 20, a hard disk drive (HDD) 30, an image forming unit 40, and a user control unit 50. The scanner unit 10 comprises a document feeder (DF) 11, a scanner 12, and an image reader CCD 13. The control unit 20 comprises a CPU, ROM, and RAM or the like, and can function as the mode setting means 21, determination means 22, and scrolling means 23.

The image forming unit 40 comprises a laser scanning unit (LSU) 41 and an electrostatic copy mechanism which has a photosensitive drum or the like. The user control unit 50 comprises an LED display unit 53, a liquid crystal display unit 52, and a key entry unit 51 which has various keys assigned for up and down cursor keys, 10 digit keys, and a start button.

A document which has been transported on to a document platen, not shown in the drawings, by the document feeder (DF) 11 is optically scanned by the scanner 12 and the document image is read by the image reader CCD 13. The document image which has been read by the image reader CCD 13 is stored in the HDD 30 by the control unit 20. The image data which is stored in the HDD 30 is sent to the LSU 41 by the control unit 20. The LSU 41 generates laser light according to the image data which was sent, the light is modulated and deflected to form an electrostatic latent image pattern on the photosensitive drum.

This copy machine is capable of vertically scrolling the screen displayed in the liquid crystal display unit 52 in line units and in page units. Herein, vertically scrolling in page units refers to vertically scrolling with a plurality of lines corresponding to the height of the display screen region equivalent to a single unit.

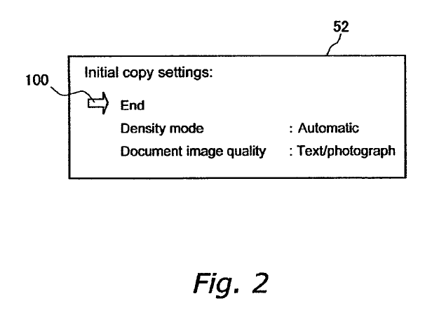

For instance, the screen shown in FIG. 2 (part of a list screen) is displayed by the liquid crystal display unit 52. In FIG. 2, arrow 100 is a cursor. Under the conditions shown in FIG. 2, the cursor 100 will move down by one line when the down cursor is pressed down once. If the down cursor key is pressed down while the cursor 100 is on the bottom line of the display screen, the display screen will move up by one line. In this case, the cursor 100 will remain at the bottom line of the display screen.

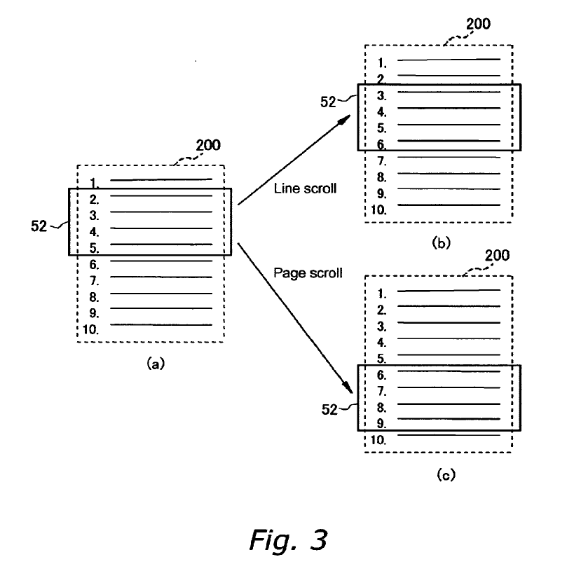

In other words, as shown in FIG. 3(a), when a portion of the list screen 200 is displayed in the liquid crystal display unit 52 and the cursor 100 is at the bottom of the display screen, the display screen will move up by one line when the down cursor key is pressed down, and therefore the display screen will change as shown in FIG. 3(b).

On the other hand, under the conditions shown in FIG. 2, the cursor 100 will move up by one line when the up cursor key is pressed down once. If the up cursor key is pressed down while the cursor is on the top line of the display screen, the display screen will move down by one line. In this case, the cursor 100 will remain at the top line of the display screen.

Next, vertical scrolling by page units will be described. After simultaneously pressing down the up and down cursor keys, the display screen will move up by page units when the down cursor key is pressed. In other words, as shown in FIG. 3(a), when a portion of the list screen 200 is displayed in the liquid crystal display unit 52, the display screen will move up by page units (unit equivalent to a plurality of lines corresponding to the height of the display screen region) when the down cursor key is pressed down after the up and down cursor keys have been simultaneously pressed down, and therefore the display screen will change as shown in FIG. 3(c). On the other hand, after simultaneously pressing down the up and down cursor keys, the display screen will move down by page units when the up cursor key is pressed.

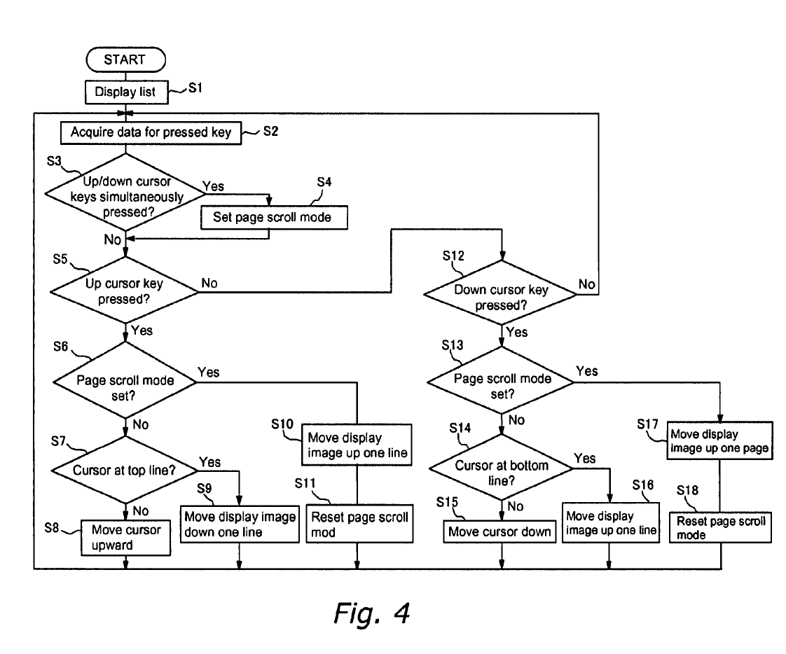

FIG. 4 shows the procedure for controlling the scrolling by means of the control unit 20.

With the list displayed on the liquid crystal display unit 52 (Step S1), when at least one of the up or down cursor keys is pressed down, the information associated with the pressed key will be acquired (Step S2), and a determination will be made as to whether or not the up and down cursor keys were simultaneously pressed down based on the acquired key information (Step S3). If the up and down cursor keys have been simultaneously pressed down, the page scroll mode will be set (Step S4), and Step S5 will begin.

In Step S3, if it is determined that the up and down cursor keys were not simultaneously pressed down, a determination will be made as to whether or not the up cursor key has been pressed down (Step S5). If the up cursor key is determined to have been pressed down, a determination will be made as to whether or not the page scroll mode has been set (Step S6). If the page scroll mode has not been set, a determination will be made as to whether or not the cursor is on the top line of the display screen (Step S7). If the cursor is not on the top line of the display screen, the cursor will move up one line (Step S8), and the process will return to Step S2.

In Step S7, if it is determined that the cursor is on the top line of the display screen, the display screen will move (scroll) down by one line (Step S9), and the process will return to Step S2. In this case, the cursor 100 will remain on the top line of the display screen.

In Step S6, if it is determined that the page scroll mode has been set, the display screen will move (scroll) down by one page unit (Step S10), and the page scroll mode will be reset (Step S11). The process will then return to Step S2.

In Step S5, if it is determined that the up cursor keys was not pressed down, a determination will be made as to whether or not the down cursor key has been pressed down (Step S12). If it is determined that the down cursor key has not been pressed down, the process will return to Step S2.

In Step S12, if the down cursor key is determined to have been pressed down, a determination will be made as to whether or not the page scroll mode has been set (Step S13). If the page scroll mode has not been set, a determination will be made as to whether or not the cursor is on the bottom line of the display screen (Step S14). If the cursor is not on the bottom line of the display screen, the cursor will move down one line (Step S15), and the process will return to Step S2.

In Step S14, if it is determined that the cursor is on the bottom line of the display screen, the display screen will move (scroll) up by one line (Step S16), and the process will return to Step S2. In this case, the cursor 100 will remain at the top line of the display screen.

In Step S13, if it is determined that the page scroll mode has been set, the display screen will move (scroll) up by one page unit (Step S17), and the page scroll mode will be reset (Step S18). The process will then return to Step S2.

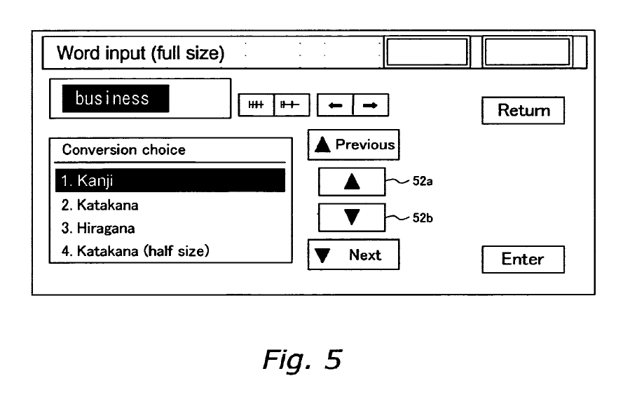

In the aforementioned embodiment, the up and down cursor keys are established on the key entry unit 51, but if the liquid crystal display unit 52 is a touch panel type, the up and down cursor keys may be established as operation buttons displayed on the liquid crystal display unit 52. In this case, a display screen which includes an up cursor key 52a and a down cursor key 52b will be displayed as shown for example in FIG. 5.

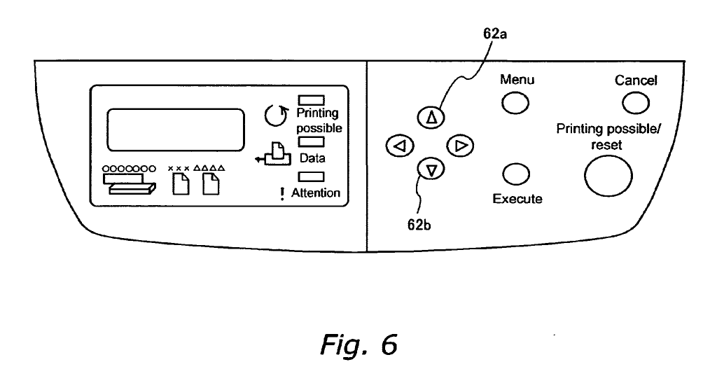

In addition, the present invention is not restricted to copy machines, and may also be a multi-function device which includes a printer function, a fax function, or the like, or may be simply a printer, a fax machine, or the like. In the case of a printer, the up cursor key 62a and the down cursor key 62b may be established on the key entry unit as shown in FIG. 6.

Furthermore, the present invention is not restricted to image forming devices such as copy machines, multi-function devices, or the like, and may be applied to other electronic devices such as portable phones and information processing devices so long as the display units have a cursor scrolling display.

In addition, in the aforementioned embodiment, a structure where the page scroll mode will function after the up and down cursor keys are simultaneously pressed down was described, but instead of simultaneously pressing down the up and down cursor keys, the page scroll mode may function if either the up or down cursor keys is pressed down for more than a predetermined period of time or pressed down a predetermined number of times.

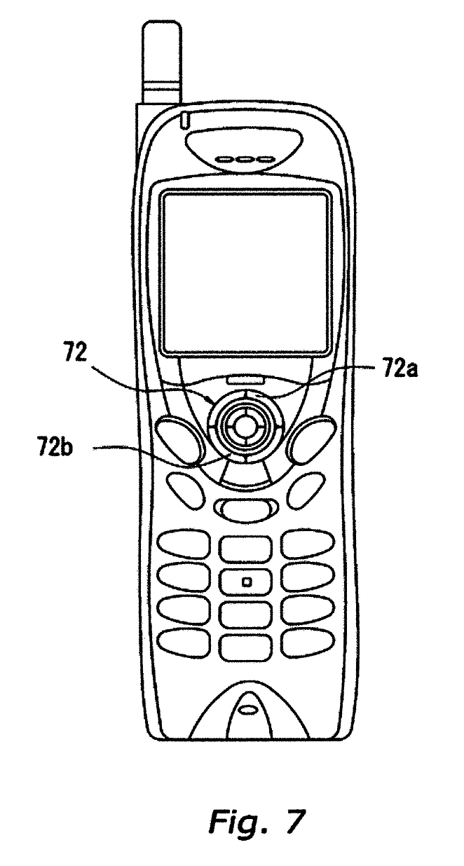

Moreover, if the up cursor key and the down cursor key are separated, the page scroll mode may be set by pressing down the region between these keys. This type of construction is effective, as shown in FIG. 7, for portable phones. For example, when the up and down cursor keys 72a, 72b are integrated into a single control button 72, or when the up cursor key and the down cursor key are located apart from each other, simultaneously operation by pressing by hand or by means of an operating means or the like is difficult. An example of the latter case is when simultaneous operation using a functioning means such as a mouse is not possible, such as when the up and down cursor keys are displayed on a personal computer display.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

What is claimed is:

1. An electronic device having a display apparatus, and an up cursor key and a down cursor key for moving a cursor displayed on the display apparatus and scrolling a display screen displayed in the display apparatus in line units, comprising:
mode setting means that sets a page scroll mode in order to scroll the display screen by page units if a predetermined operation is performed with at least one of either the up cursor key or the down cursor key;
determination means that determines whether or not the page scroll mode has been set when only one of either the up cursor key or the down cursor key has been operated; and
scrolling means that both scrolls the display screen in page units in the direction of the up cursor key or down cursor key that was operated if the determination means determines that the page scroll mode has been set, and resets the page scroll mode.

2. The electronic device according to claim 1, wherein the setting means sets the page scroll mode if the up cursor key and the down cursor key are simultaneously operated.

3. The electronic device according to claim 1, wherein the setting means sets the page scroll mode if at least one of the up cursor key or the down cursor key has been operated for more than a predetermined period of time.

4. The electronic device according to claim 1, wherein the setting means sets the page scroll mode if at least one of the up cursor key or the down cursor key has been operated a predetermined number of times.

5. The electronic device according to claim 1, wherein the up cursor key and the down cursor key are located apart from each other, and the setting means sets the page scroll mode if the region between the up cursor key and the down cursor key is operated.

6. The electronic device according to claim 1, further comprising an image forming unit for forming an image on a transfer material.

7. A storage medium which stores a control program which is executed by an electronic device having a display apparatus, and an up cursor key and a down cursor key for moving a cursor displayed in the display apparatus and scrolling the display screen displayed in the display apparatus in line units, said control program causing the electronic device to execute:
mode setting means that sets a page scroll mode in order to scroll the display screen by page units if a predetermined operation is performed with at least one of either the up cursor key or the down cursor key;
determination means that determines whether or not the page scroll mode has been set when only one of either the up cursor key or the down cursor key has been operated; and
scrolling means that both scrolls the display screen in page units in the direction of the up cursor key or down cursor key that was operated if the determination means determines that the page scroll mode has been set, and resets the page scroll mode.
